(19) United States
(12) Patent Application Publication
(10) Pub. No.: US 2014/0102583 A1
(43) Pub. Date: Apr. 17, 2014

(54) Ice Vending Machine

(71) Applicant: ICE HOUSE AMERICA, LLC, Jacksonville Beach, FL (US)

(72) Inventors: Ernest Chip Venet, III, Jacksonville Beach, FL (US); Steven Alan Weeks, Jacksonville Beach, FL (US); Daniel LaDon Dunn, Jacksonville Beach, FL (US); Troy Doom, Jacksonville Beach, FL (US)

(73) Assignee: ICE HOUSE AMERICA, LLC, Jacksonville Beach, FL (US)

(21) Appl. No.: 13/799,709

(22) Filed: Mar. 13, 2013

Related U.S. Application Data
(60) Provisional application No. 61/714,412, filed on Oct. 16, 2012.

(51) Int. Cl. B67D 7/76

(52) U.S. Cl. CPC B67D 7/76
USPC 141/11; 141/69; 141/82

(57) ABSTRACT

An ice vending machine automatically provides ice to a customer based upon a request from the consumer for the ice. In some embodiments, the ice vending machine includes an ice bagging system. In some embodiments, the bagging system operates without the use of a counterweight. In some embodiments, the ice vending machine includes a view window to view the ice being bagged. In some embodiments, the ice vending machine is an ice and liquid water vending machine that automatically provides ice or liquid water to a customer based on a request from the customer for the ice or liquid water. In some embodiments, the ice and liquid water vending machine includes an ultraviolet light flushing assembly. In some embodiments, the ice and liquid water vending machine includes a chill tank.

### REFERENCE TO RELATED APPLICATIONS

This application claims one or more inventions which were disclosed in Provisional Application No. 61/714,412, filed Oct. 16, 2012, entitled “ICE VENDING MACHINE”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of vending machines. More particularly, the invention pertains to ice vending machines.

2. Description of Related Art

Ice vending machines that dispense ice automatically on demand to a customer are known in the art. U.S. Pat. No. 6,474,048, entitled “Automatic ice producing, bagging, and dispensing machine” and issued Nov. 5, 2002 to Metzger et al., U.S. Pat. No. 6,932,124, entitled “Automated Ice Bagging Apparatus and Methods” and issued Aug. 23, 2005 to Dalton et al., U.S. Pat. No. 7,104,291, entitled “Automated Ice Bagging Apparatus and Methods” and issued Sep. 12, 2006 to Dalton et al., U.S. Pat. No. 7,426,945, entitled “Automated Ice Bagging Apparatus and Methods” and issued Sep. 23, 2008 to Dalton et al., U.S. Pat. No. 7,735,527, entitled “Automated Ice Delivery Apparatus and Methods” and issued Jun. 15, 2010 to Dunn, U.S. Pat. No. 7,806,152, entitled “Automated Ice Bagging Apparatus and Methods” and issued Oct. 5, 2010 to Dalton et al., U.S. Pat. No. 8,122,689, entitled “Method and apparatus for producing, bagging and dispensing ice” and issued Feb. 28, 2012 to Pape, U.S. Pat. No. 8,245,488, entitled “Automated Ice Delivery Apparatus and Methods” and issued Aug. 21, 2012 to Dunn, U.S. Patent App. Pub. No. 2010/0319806, entitled “Automated Ice Bagging Apparatus and Methods” by Dalton et al. and published Dec. 23, 2010, and U.S. Patent App. Pub. No. 2012/0247066, entitled “Ice Bagging Apparatus and Methods” by Dunn et al. and published Oct. 4, 2012, each disclose a vending machine that dispenses ice on demand to a customer.

Ice vending machines that dispense both ice and liquid water automatically on demand to a customer are also known in the art. U.S. Pat. No. 5,112,477, entitled

“Purified water and ice dispensing apparatus” and issued May 12, 1992 to Hamlin, U.S. Pat. No. 5,484,538, entitled “Multiple service water purifier and dispenser and process of purifying water” and issued Jan. 16, 1996 to Woodward, U.S. Pat. No. 6,093,312, entitled “Ice Dispenser with an Air-Cooled Bin” and issued Jul. 25, 2000, and U.S. Patent App. Pub. No. 2012/0186276, entitled “Ice and Chilled Water Producing and Dispensing Machine” by Seymour and published Jul. 26, 2012, each disclose a vending machine that dispenses both ice and liquid water.

The above-mentioned references are hereby incorporated by reference herein.

### SUMMARY OF THE INVENTION

An ice vending machine automatically provides ice to a customer based upon a request from the consumer for the ice. In some embodiments, the ice vending machine includes an ice bagging system. In some embodiments, the bagging system operates without the use of a counterweight. In some embodiments, the ice vending machine includes a view window to view the ice being bagged. In some embodiments, the ice vending machine is an ice and liquid water vending machine that automatically provides ice or liquid water to a customer based on a request from the customer for the ice or liquid water. In some embodiments, the ice and liquid water vending machine includes an ultraviolet light flushing assembly. In some embodiments, the ice and liquid water vending machine includes a chill tank.

### BRIEF DESCRIPTION OF THE DRAWINGS

FIG. 1 shows a side view of a bagging system assembly for ice in operation in an embodiment of the present invention.

FIG. 2 shows a front view of the bagging system assembly of FIG. 1 in operation.

FIG. 3 shows a close-up side view of the drop floor assembly of the bagging system assembly of FIG. 1.

FIG. 4 shows an elevated perspective view of the bagging system assembly of FIG. 1 without the ice.

FIG. 5 shows an exploded view of the bagging system assembly of FIG. 4.

FIG. 6 shows a top view of the bagging system assembly of FIG. 4.

FIG. 7 shows a front view of the bagging system assembly of FIG. 4.

FIG. 8 shows a side view of the bagging system assembly of FIG. 4.

FIG. 9 shows a back view of the bagging system assembly of FIG. 4.

FIG. 10 shows a front view of a portion of an ice and water vending machine with a view window for viewing the process of bagging the ice in an embodiment of the present invention.

FIG. 11 shows a UV light flushing assembly in an embodiment of the present invention.

FIG. 12 shows a chill tank in an embodiment of the present invention.

FIG. 13 shows a cut-away view of the chill tank of FIG. 12.

FIG. 14 shows schematically an automated ice vending machine in an embodiment of the present invention.

### DETAILED DESCRIPTION OF THE INVENTION

An ice vending machine automatically provides ice to a customer based upon a request from the consumer for the ice. In some embodiments, the request includes a payment from the customer. In some embodiments, the ice is bagged by the ice vending machine after the request from the customer is made and prior to dispensing the ice to the customer. In some embodiments, the ice vending machine is an ice and liquid water vending machine that also automatically provides liquid water to a customer based on a request from the customer for the liquid water. In some embodiments, the liquid water is chilled to a temperature below room temperature. In some embodiments, the liquid water is put in a container supplied by the ice vending machine after the request from the customer is made and prior to dispensing the ice to the customer.

An automated ice vending machine preferably includes a customer request apparatus, an ice supplying apparatus, an ice bagging apparatus, and a bagged ice vending apparatus. The customer request apparatus preferably receives a request from a customer for the ice in the form of a customer input, which may include, but is not limited to, a payment by the customer or a selection of a particular size of ice, a particular amount of ice, or a particular number of bags of ice. A programmable logic control or other computerized control system or logic preferably receives and validates the request and initiates the vending process by directing the ice supplying apparatus to begin supplying ice to the ice bagging apparatus upon receipt of a valid request from a customer. The computerized control system preferably also controls and directs the rest of the automated vending process.

The ice supplying apparatus preferably includes a holding vessel to hold the ice pieces to be vended. The holding vessel is sufficiently insulated to retain a majority of the ice pieces in solid form so as to minimize or avoid substantial melting of the ice. The holding vessel is preferably insulated from the environment by an insulation chamber.

In some embodiments, the ice supplying apparatus includes an ice making apparatus. In such embodiments, the ice making apparatus preferably forms ice pieces by freezing liquid water from a liquid water source and supplies the ice pieces to the holding vessel, as needed, such as when the amount of ice pieces in the holding vessel goes below a predetermined amount. In other embodiments, ice pieces are supplied to the holding vessel from an outside source rather than being made by the automated ice vending machine.

An ice transferring apparatus preferably includes a transport apparatus positioned in the holding vessel and configured and adapted to transport a portion of the ice pieces from the holding vessel to the ice bagging apparatus. The transport apparatus may include, but is not limited to, a conveyor belt, a chain, or a plurality of side-by-side rollers. The transport apparatus preferably operates in a continuous loop and is preferably motorized.

The ice bagging apparatus preferably includes a supply of bags in a bag supply zone, a bagging zone where one bag to be filled from the bag supply is opened and ice pieces from the ice supplying apparatus are received in the opened bag. In some embodiments, the bag supply zone includes a wicket on which the supply of bags is hung in a flattened stack. In some embodiments, a blower blows air to open the back at an open end of the bag. The ice bagging apparatus preferably includes a measuring apparatus to determine when the opened bag contains an appropriate predetermined amount of ice pieces. The measuring apparatus may include, but is not limited to, a scale, a counterbalance, or a beam sensor.

In some embodiments, the bagged ice is provided to the customer without closing the open end of the bag. In other embodiments, the ice bagging apparatus includes a bag closing apparatus. In some embodiments, the ice closing apparatus heat-seals the open end of the bag closed. In other embodiments, the ice closing apparatus applies a fastener to the open end of the bag. Fasteners may include, but are not limited to, staples, ties, or adhesives.

Once the ice bagging apparatus has determined that the opened bag contains the appropriate predetermined amount of ice pieces, the bagged ice vending apparatus delivers the bagged ice to the customer. In some embodiments, the bagged ice vending apparatus includes a vend door that the customer may open to remove the bagged ice from the bagging zone. In other embodiments, the bagged ice is released and travels down a vending chute to a vend window, from which the customer takes the bagged ice. In other embodiments, the bagged ice is actively transported to a vend window.

In embodiments where the automated ice vending machine is an automated ice and liquid water vending machine, the automated ice vending machine preferably also includes a water supplying apparatus, a water vending apparatus, and at least one of a ultraviolet light irradiating assembly and a chill tank. The water supply apparatus is preferably a water inlet pipe that may be coupled to a municipal water line, a well water line, or any other source of potable water. The water supply apparatus may also supply the liquid water to be frozen by the ice forming apparatus.

The water vending apparatus supplies liquid water to the customer upon receipt of a valid request from the customer for liquid water through the customer request apparatus. In some embodiments, the liquid water is purified by an ultraviolet light irradiating assembly prior to being supplied to the water vending apparatus. In some embodiments, the computerized control system determines whether the control valve of the ultraviolet light irradiating assembly has been actuated within a predetermined period of time prior to receiving the vend request and actuates the control valve to supply a predetermined amount of the liquid water from the irradiation zone of the ultraviolet light irradiating assembly to the flush line, if the control valve has not been actuated within the predetermined period of time. The computerized control system then actuates the control valve to supply liquid water to the vending line to supply liquid water to the customer. In some embodiments, the liquid water is chilled by passage through the coils of a chill tank prior to being supplied to the water vending apparatus. In some embodiments, the liquid water is chilled by heat exchange in the chill tank with cold liquid water flushed from the ice forming apparatus of the automated ice and liquid water vending apparatus.

In some embodiments, the bags for bagging the ice rest in a stack on a wicket to be dispensed. In some embodiments, the ice bagging system includes the following method. Once a credit or a request in another form is received from a customer, the control board activates a blower that blows the front bag on the wicket open. Proximity sensors detect that the bag is open and send a signal to the control board, which activates the dispensing auger that augers ice from the storage bin into the blown-open bag. Through beam receivers, the control board receives a signal that the bag is filled with ice, once the beam has been broken. The control board activates a 2-inch actuator that supports a drop floor, on which the filled bag rests. The activated actuator drops, thereby allowing the drop floor to drop under the weight of the bagged ice. When the drop floor drops, the weight of the ice inside the bag rips the bag off the wicket and the bag of ice drops through the vending chute. The control board then activates the same actuator to open, which pushes the drop floor back up to await the next vend. The bagging system preferably works without the use of a counterweight or other weighing apparatus. Instead, the bagging system preferably relies on the beam receivers to determine whether a bag is full of ice.

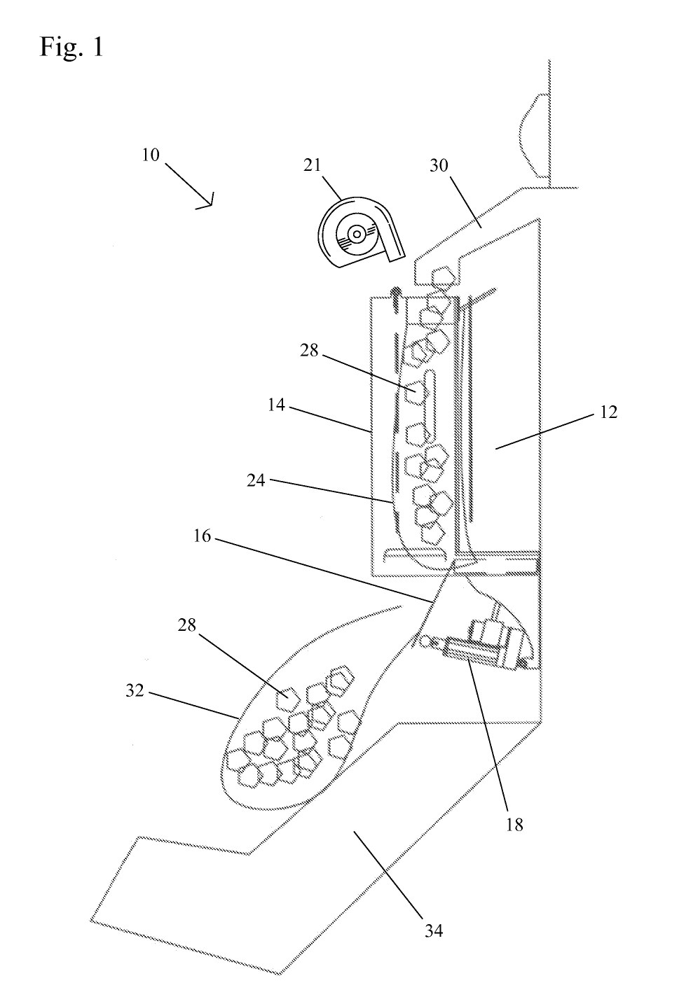

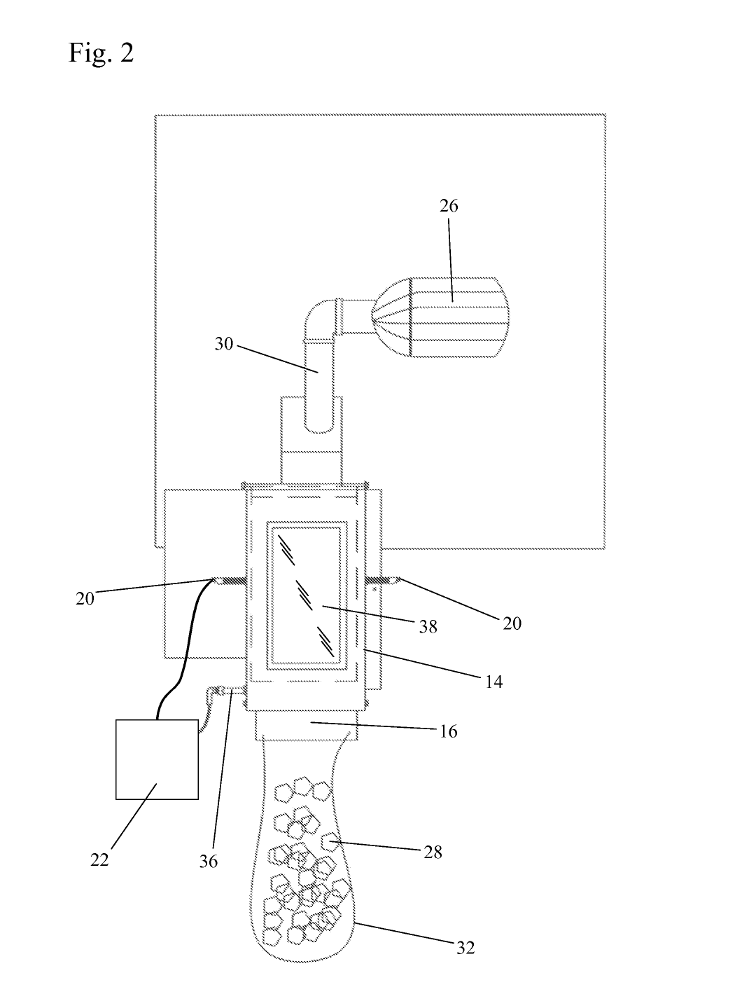

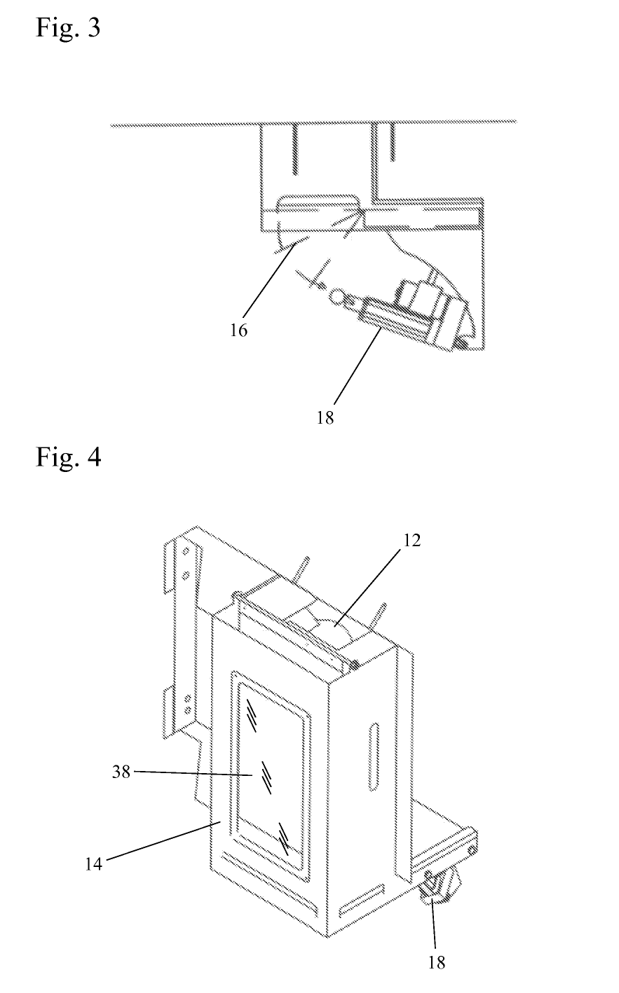

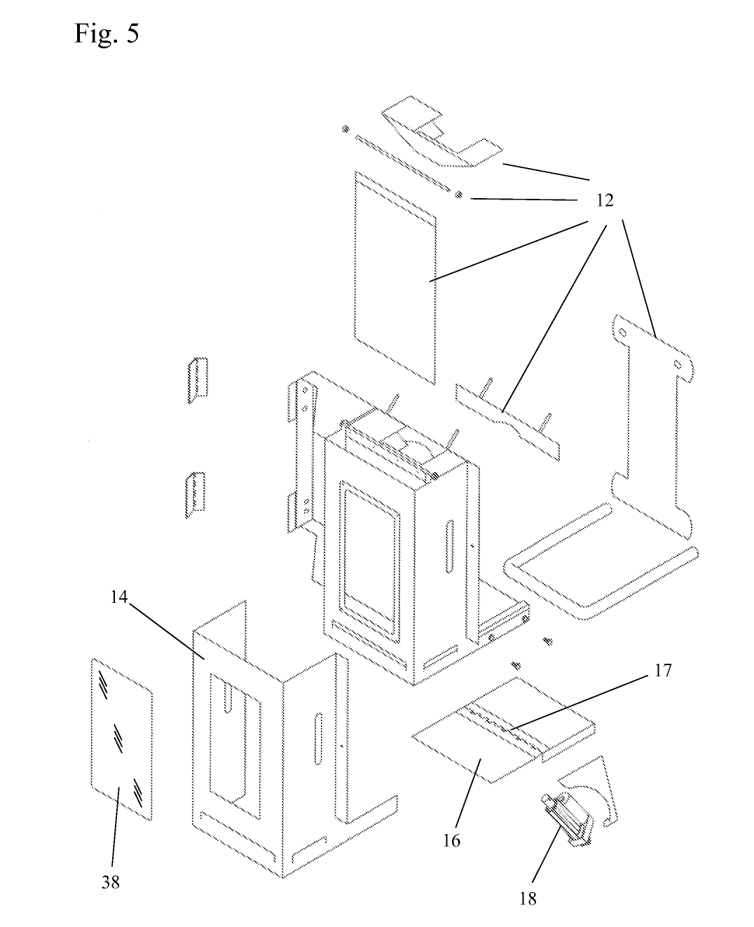

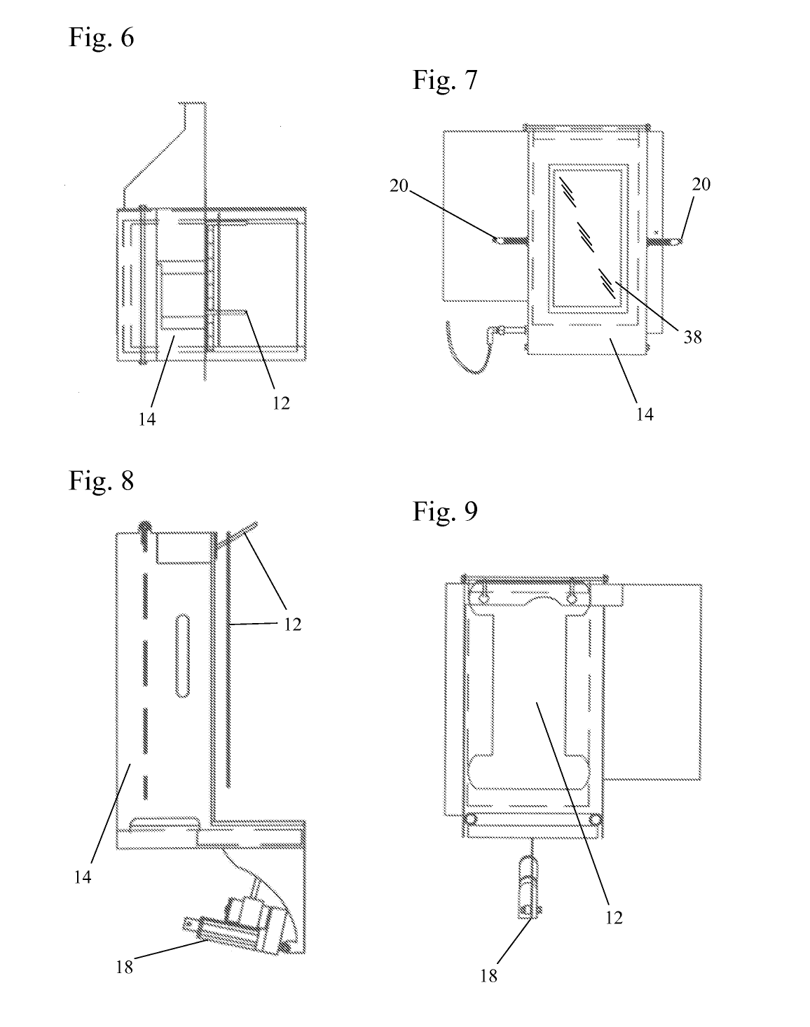

FIG. 1 through FIG. 9 show a bagging system for an ice vending machine for automatically bagging ice upon a request input from a customer. In some embodiments, the ice vending machine vends ice but not liquid water. In other embodiments, the ice vending machine is an ice and liquid water vending machine. The bagging system 10 includes a wicket 12, a bagging enclosure 14, a drop floor 16, a drop floor actuator 18, at least one beam receiver 20, and at least one proximity sensor 36. The control board 22 of the vending machine, which is in electronic communication with the drop floor actuator 18 and the beam receiver 20, activates a blower 21 that blows a vending bag 24 open inside the bagging enclosure 14 with the drop floor 16 in a closed or up position. Although the control board 22 is shown in a particular location in FIG. 2, the control board 22 may be located anywhere within or on the vending machine. At least one proximity sensor 36 detects the vending bag 24 and sends a signal to the control board 22, which activates the dispensing auger 26 that augers ice 28 from the storage bin (not shown), down an ice chute 30, and into the blown-open bag 24. Through the beam receivers 20, the control board 22 receives a signal that the vending bag 24 is filled with ice 28, once the beam has been broken. The control board 22 then activates the drop floor actuator 18 that allows the drop floor 16, on which the filled vending bag 24 rests, to open by hingedly pivoting at a pivot point 17 downward. The activated actuator 18 drops, thereby allowing the drop floor 16 to drop under the weight of the ice-filled bag 24. When the drop floor 16 drops, the weight of the ice 28 inside the bag 24 rips the bag off the wicket 12 and the filled ice bag 32 drops through the vending chute 34 below the bagging enclosure 14 and to the customer. The control board 22 then activates the same actuator 18 to open, which pushes the drop floor 16 back up to await the next vend.

In some embodiments, the ice vending machine includes a view window to allow the customer to watch the ice vending process. This design element enhances the customer experience by allowing the customer to view the ice during the bagging process. The experience may be further enhanced by the use of accent lighting behind the view window. Conventional automated ice vending machines do not have any design attributes to allow the customer to view the ice during the bagging process. A viewing window, preferably with accent lighting, allows the consumer to see the ice during the bagging and delivery process. This design element conveys the concepts of freshness and the product not being touched by human hands during the ice making process. In a preferred embodiment, the bagging system 10 of FIG. 1 through FIG. 9 includes a viewing window 38. The viewing window 38 is transparent and sits in the front wall of the bagging enclosure 14. The viewing window 38 may be made of any solid transparent material, including, but not limited to, a transparent glass or a transparent plastic.

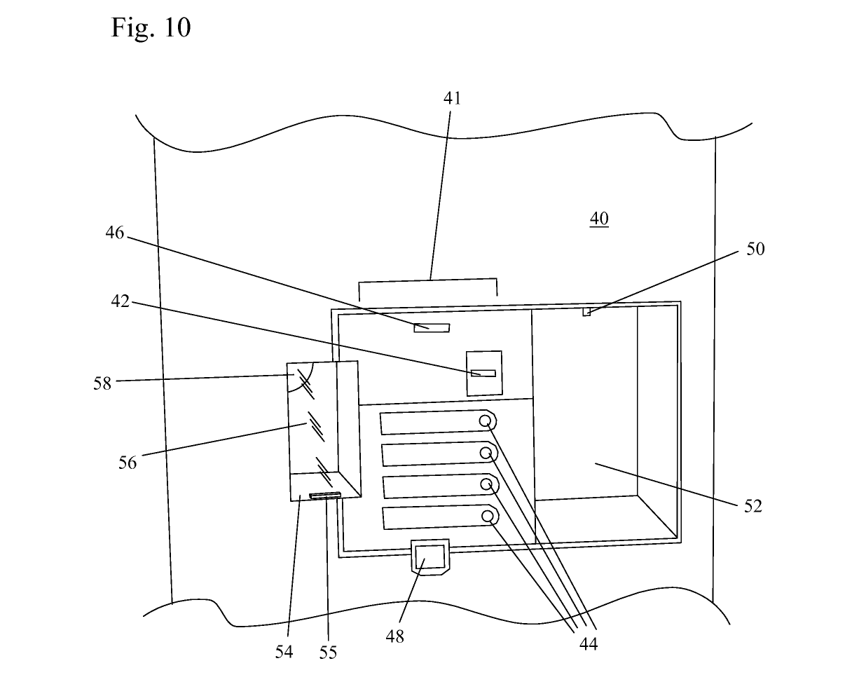

FIG. 10 shows a line drawing of the front 40 of an ice and liquid water vending machine. The front 40 of the vending machine includes a customer request area 41, an ice vending area, and a liquid water vending area 52. The customer request apparatus 41 includes a payment slot 42, one or more vending buttons 44, a digital screen 46, and a change/receipt window 48. The customer may insert payment into the payment slot 42 and then the customer may select one or more vending options by pushing one or more of the vending buttons 44. The payment slot 42 may receive cash, in the form of bills or coins, or a credit, debit, membership, or other card associated with an account of the customer. The digital screen 46 provides messages to the customer, and the change/receipt window 48 provides change or a receipt to the customer. If the customer requests liquid water, liquid water is dispensed out a nozzle 50 into a liquid water vending area 52. The liquid water is dispensed into a container placed in the liquid water vending area 52. The container may be supplied by the vending machine or the customer. The container may be of any size that fits in the liquid water vending area 52 and may hold any volume, although the volume preferably corresponds to the volume of liquid water requested by the customer.

A view window 54, which may be made of any solid transparent material, including, but not limited to, glass or plastic, allows the customer to see the ice bagging area 56 behind the view window 54. In some embodiments, an anti-fogging coating on one or both sides of the transparent material prevents condensation from forming on the surface of the transparent material that would prevent a customer from being able to see through the view window 54. In a preferred embodiment, accent lighting 58 provides light to the ice bagging area 56 to provide the customer with a better view. In some embodiments, the view window 54 may be lifted by the customer using a handle 55 when the bag has been filled with the ice to allow the customer to remove the bag of ice from the vending machine. In some embodiments, the vending machine locks the view window 54 when the ice bagging area 56 is empty or when the bag is not yet ready to be removed by the customer. In other embodiments, the view window 54 is permanently in place and the filled bag of ice is transferred to a vending chute by the vending machine to supply the filled bag to the customer. In other embodiments, the view window allows the customer to see other stages of the ice making and ice bagging process. In some embodiments, the vending machine includes multiple view windows to see different stages of the ice making and ice bagging process. The view window or view windows may be of any size or shape to allow viewing of a portion or all of the ice formation and bagging process.

In embodiments where the ice vending machine also dispenses liquid water, the liquid water is preferably irradiated with ultraviolet (UV) light just prior to being dispensed. The UV light sterilizes the water passing through it, but if the water sits inside the UV compartment for a long period of time, the UV light may heat the water up to temperatures as high as 120° F. The customer, however, in most cases is expecting the dispensed water to be chilled. In some embodiments, to eliminate the heated water from being dispensed to the customer, when the controller determines that water has not been dispensed for a certain predetermined period of time, the controller causes a valve to be opened that allows water to be flushed out of the UV compartment. The valve is preferably a solenoid valve. In other embodiments, the controller waits until there is a customer request. At that time, the controller determines whether water has been dispensed within a certain predetermined period of time, and if the time since the last dispensing event has exceeded the predetermined period of time, the controller causes a solenoid valve to be opened that allows water to be flushed out the UV compartment prior to dispensing water to the customer.

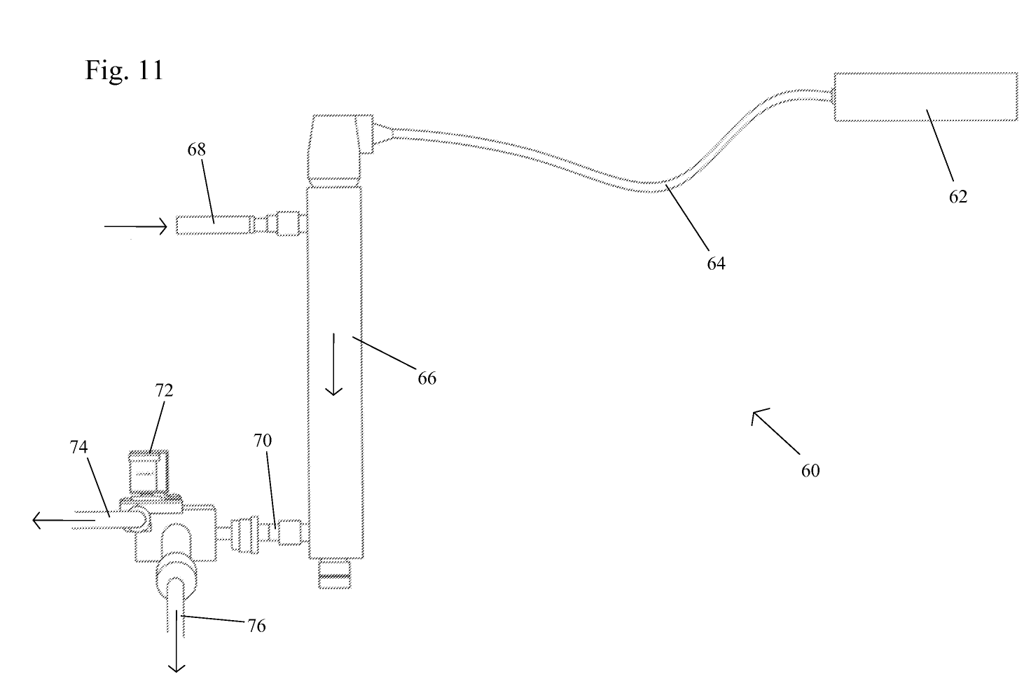

FIG. 11 shows an ultraviolet light irradiating and warm water flushing assembly 60 for an ice and liquid water vending machine. An ultraviolet light source 62 generates ultraviolet light, which is transmitted along a conduit 64 to a liquid water irradiating zone 66. The water to be irradiated enters the irradiating zone 66 by way of an inlet line 68 and exits the irradiating zone 66 by way of an outlet line 70. A controller 72 directs a valve to control whether irradiated liquid water from the outlet line 70 is flushed through a flush line 74 or travels through a vending line 76 to the customer. The liquid water entering through the inlet line 68 is preferably chilled prior to entering the irradiating zone 66.

In embodiments where the ice vending machine also dispenses liquid water, the liquid water is preferably chilled prior to being dispensed. In some embodiments, an insulated tank receives and holds the liquid water being flushed out by the ice maker after the ice maker harvests a batch of ice. This cold liquid water in the insulated tank is then used to chill the water to be dispensed before it is dispensed to the customer. Coiled tubing rests inside the insulated tank, and the incoming water line passes through the coiled tubing to remove heat from the water before it is dispensed to a customer.

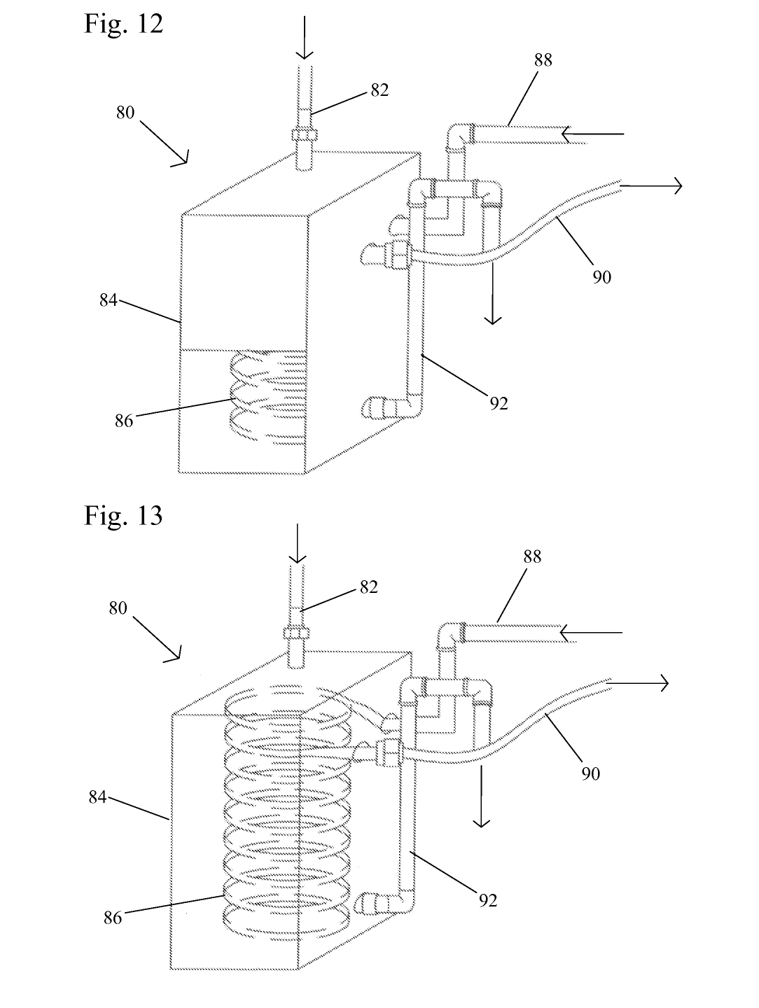

FIG. 12 and FIG. 13 show a chill tank 80 for an ice and liquid water vending machine. The cold water being flushed out by the ice maker after the ice maker harvests a batch of ice travels down a tank inlet line 82 to an insulated tank 84 to serve as cooling water. Coiled tubing 86 runs inside the insulated tank 84. Incoming unchilled water flows into the coiled tubing 86 by way of a water inlet line 88 and is chilled in the coiled tubing 86 by heat transfer to the cooling water in the insulated tank 84. The chilled water then exits the coiled tubing 86 by way of a water outlet line 90 and is dispensed to the customer. A tank outlet line 92 drains excess cooling water from the insulated tank 84.

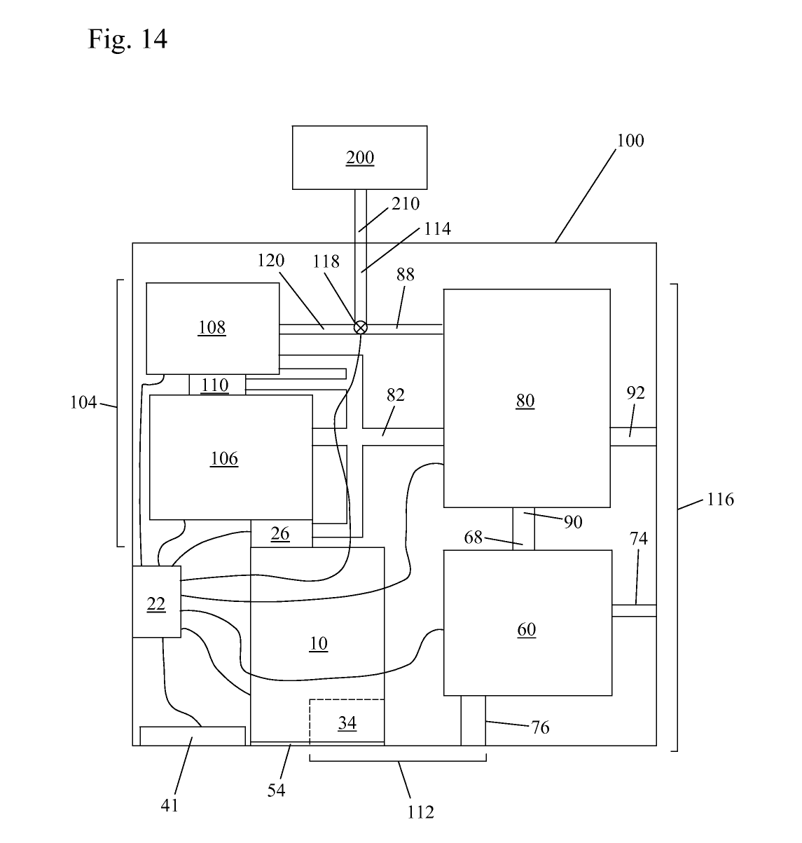

FIG. 14 schematically shows an automated ice vending machine. The automated ice vending machine 100 includes a customer request apparatus 41, an ice supplying apparatus 104, an ice bagging apparatus 10, and a bagged ice vending apparatus 34. The customer request apparatus 41 receives a request from a customer for the ice in the form of a customer input, which may include, but is not limited to, a payment by the customer or a selection of a particular size of ice, a particular amount of ice, or a particular number of bags of ice. A control board 22 including a programmable logic control or other computerized control system or logic receives and validates the request and initiates the vending process by directing the ice supplying apparatus 104 to begin supplying ice to the ice bagging apparatus 10 upon receipt of a valid request from a customer.

The ice supplying apparatus 104 includes a holding vessel 106 to hold the ice pieces to be vended. The holding vessel 106 is sufficiently insulated to retain a majority of the ice pieces in solid form so as to minimize or avoid substantial melting of the ice. The holding vessel 106 is preferably insulated from the environment by an insulation chamber. The ice supplying apparatus 104 also includes an ice making apparatus 108. The ice making apparatus 108 forms ice pieces by freezing liquid water from a liquid water source, preferably a municipal liquid water source 200, and supplies the ice pieces to the holding vessel 106, as needed, when the amount of ice pieces in the holding vessel goes below a predetermined amount. The ice is passively supplied from the ice making apparatus 108 to the holding vessel 106 by traveling down a chute 110 between the ice making apparatus 108 and the holding vessel 106. In other embodiments, the ice may be actively transported from the ice making apparatus 108 to the holding vessel 106. The ice supplying apparatus 104 also includes an ice transport apparatus 26 positioned in the holding vessel 106 and configured and adapted to transport a metered portion of the ice pieces from the holding vessel 106 to the ice bagging apparatus 10.

A view window 54 in front of the ice bagging apparatus 10 allows the customer to view at least a portion of the ice bagging apparatus 10 in order to view the bagging process. Once the ice bagging apparatus 10 has determined that the opened bag contains the appropriate predetermined amount of ice pieces, the bagged ice vending apparatus 34 delivers the bagged ice to the customer. The bagged ice vending apparatus 34 is shown with dotted lines, as it lies below the ice bagging apparatus 10. The bagged ice is released from ice bagging apparatus 10 and travels down the vending chute 34 to the vend window 112, from which the customer takes the bagged ice.

The automated ice vending machine 100 of FIG. 14 is an automated ice and liquid water vending machine. The automated ice vending machine 100 also includes a water supplying apparatus 114 and a water vending apparatus 116, including an ultraviolet light irradiating assembly 60 and a chill tank apparatus 80. The water supply apparatus 114 is a water inlet pipe coupled to any drinkable water line, preferably a liquid water line 210 receiving liquid water from a municipal liquid water source 200. The water supply apparatus 114 also supplies the liquid water to be frozen by the ice forming apparatus 108. A water inlet valve 118 preferably controls whether liquid water is supplied to the liquid water inlet 88, the ice making apparatus inlet 120, neither inlet, or both inlets. In other embodiments, separate lines controlled by separate valves may supply liquid water to the ice making apparatus 104 and the liquid water vending apparatus 116.

The water vending apparatus 116 supplies liquid water to the customer upon receipt of a valid request from the customer for liquid water through the customer request apparatus 41. The liquid water is purified by the ultraviolet light irradiating assembly 60 prior to being supplied to the customer through the liquid water vending line 76. In some embodiments, the control board 22 determines whether the control valve of the ultraviolet light irradiating assembly 60 has been actuated within a predetermined period of time prior to receiving the vend request and actuates the control valve to supply a predetermined amount of the liquid water from the irradiation zone of the ultraviolet light irradiating assembly 60 to the flush line 74, if the control valve has not been actuated within the predetermined period of time. The control board 22 then actuates the control valve to supply liquid water to the liquid water vending line 76 to supply liquid water to the customer. The liquid water is chilled by passage through the coils of the chill tank apparatus 80 prior to being supplied to the ultraviolet light irradiating assembly 60 for irradiation. Although the tank inlet line 82 is shown in FIG. 14 as receiving cold water drained from the ice making apparatus 108, the chute 110, the holding vessel 106, and the ice transferring apparatus 26 of the ice supplying apparatus 104, the tank inlet line 82 may alternately receive cold water drained from one or any combination of these parts of the ice supplying apparatus 104. The liquid water is chilled by heat exchange in the chill tank apparatus 80 with cold liquid water flushed or drained from the ice supplying apparatus 104 of the automated ice and liquid water vending apparatus 100. A tank outlet line 92 drains excess cooling water from the chill tank 80. The chill tank outlet line 90 also serves as the ultraviolet light irradiating assembly inlet line 68.

The control board 22 preferably controls and directs the automated vending process by electronic communication with the customer request apparatus 41, the ice supplying apparatus 104, including the holding vessel 106, the ice making apparatus 108, and the ice transport apparatus 26, the ice bagging apparatus 10, the water inlet valve 118, and the water vending apparatus 116, including the ultraviolet light irradiating assembly 60 and the chill tank apparatus 80. As mentioned above, the control board 22 receives and validates a customer request for ice through the customer request apparatus 41 and initiates the ice vending process by directing the ice supplying apparatus 104 to begin supplying ice to the ice bagging apparatus 10 upon receipt of a valid request for ice from a customer. More specifically, the control board 22 directs the ice transport apparatus 26 to begin transporting ice from the holding vessel 106 to the ice bagging apparatus 10. The control board 22 also communicates with the holding vessel 106 to monitor whether the amount of ice in the holding vessel 106 is within a predetermined range. When the amount of ice in the holding vessel 106 goes below the predetermined range, the control board 22 communicates with the ice making apparatus 108 to make more ice and communicates with the water inlet valve 118 to supply water to the ice making apparatus 108. The control board 22 also communicates with the ice bagging apparatus 10 to initiate the ice bagging process and to determine when to stop the ice bagging process.

The control board 22 also receives and validates a customer request for liquid water through the customer request apparatus 41 and initiates the water vending process by directing the water vending apparatus 116 to begin supplying liquid water upon receipt of a valid request for water from a customer. The water vending process includes the control board 22 communicating with the water inlet valve 118 to supply water to the chill tank 80. The control board 22 also preferably monitors the chill tank 80, including monitoring the temperature of the chilling water received from the ice supplying apparatus 104 and the temperature of the water to be vended passing through the chill tank 80. The control board also monitors the ultraviolet light irradiating assembly 60 in order to direct the ultraviolet light irradiating assembly 60 to vend chilled, irradiated water to the customer or to flush a predetermined amount of the irradiated water that is no longer sufficiently chilled.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An automated ice and liquid water vending apparatus comprising:
an ice supplying apparatus;
an ice bagging apparatus receiving a plurality of ice pieces from the ice supplying apparatus into an open end of a vending bag to form a filled ice bag comprising the vending bag and the ice pieces in the vending bag;
a bagged ice vending apparatus supplying the filled ice bag to a customer;
a liquid water supplying apparatus; and
an ultraviolet light irradiating assembly comprising:
an inlet line receiving liquid source water from the liquid water supplying apparatus;
an irradiation zone downstream from the inlet line;
an ultraviolet light source irradiating the liquid source water passing through the irradiation zone with ultraviolet light;
a flush line;
a vending line supplying liquid water to the customer; and
a control valve controlling whether liquid water from the irradiation zone is supplied to the flush line, supplied to the vending line, or retained in the irradiation zone;
wherein when liquid water has been retained in the irradiation zone for at least a predetermined period of time, the control valve supplies a predetermined amount of the liquid water to the flush line before supplying liquid water to the vending line.

2. The automated ice and liquid water vending apparatus of claim 1, wherein the liquid water supplying apparatus comprises a chill tank comprising:
an insulated tank receiving cold liquid water flushed from the ice supplying apparatus; and
coiled tubing in heat exchange contact with the insulated tank, the coiled tubing receiving the liquid source water from a liquid water source, the liquid source water being cooled by heat exchange with the cold liquid water in the insulated tank as the liquid source water flows through the coiled tubing, the coiled tubing supplying the liquid source water to the inlet line of the ultraviolet light irradiating assembly.

3. The automated ice and liquid water vending apparatus of claim 2, wherein the ice bagging apparatus comprises:
a bag supplying apparatus supplying at least one vending bag having an open end;
a bag opening apparatus receiving the vending bag from the bag supplying apparatus and preparing the vending bag to receive a plurality of ice pieces from the ice supplying apparatus into the open end of the vending bag; and
a bag weighing apparatus determining when the vending bag is considered a filled ice bag and causing the ice supplying apparatus to stop supplying ice pieces to the bag weighing apparatus.

4. The automated ice and liquid water vending apparatus of claim 3, wherein the bag weighing apparatus comprises:
at least one proximity sensor; and
at least one beam receiver;
wherein the proximity sensor and the beam receiver are located such that, when the vending bag is filled with the ice pieces from the ice supplying apparatus to a level preventing the beam receiver from receiving a beam from the proximity sensor, the vending bag is considered the filled ice bag and the ice supplying apparatus stops supplying ice pieces to the bag weighing apparatus.

5. The automated ice and liquid water vending apparatus of claim 2 further comprising a control board communicating with the ice supplying apparatus, the ice bagging apparatus, and the bagged ice vending apparatus to automate vending of the ice from the automated ice vending apparatus.

6. The automated ice and liquid water vending apparatus of claim 2, wherein the ice supplying apparatus comprises:
an ice making apparatus receiving liquid water from a liquid water source and forming the plurality of ice pieces from the liquid water;
a holding vessel receiving and storing the ice pieces from the ice making apparatus; and
an ice transferring apparatus transferring and metering the ice pieces from the holding vessel to the ice bagging apparatus.

7. The automated ice and liquid water vending apparatus of claim 6, wherein the ice transferring apparatus comprises an ice transport apparatus selected from the group consisting of a conveyor belt, a chain, and a plurality of side-by-side rollers.

8. The automated ice and liquid water vending apparatus of claim 2, wherein the bag supplying apparatus comprises a wicket.

9. The automated ice and liquid water vending apparatus of claim 8, wherein the bag supplying apparatus further comprises a plurality of the at least one vending bag hanging on the wicket.

10. An automated method of supplying liquid water from an ice and liquid water vending apparatus comprising:
a) receiving a request from a customer for liquid water;
b) determining whether a control valve of an ultraviolet light irradiating assembly of the ice and liquid water vending apparatus has been actuated within a predetermined period of time prior to receiving the request; and
c) if the control valve has not been actuated within the predetermined period of time, actuating the control valve to supply a predetermined amount of the liquid water from an irradiation zone of the ultraviolet light irradiating assembly to a flush line prior to actuating the control valve to supply liquid water to a vending line to supply liquid water to the customer.

11. The automated method of claim 10 further comprising irradiating the liquid water with ultraviolet light from an ultraviolet light source of the ultraviolet light irradiating assembly.

12. The automated method of claim 10 further comprising cooling the liquid water in a cool tank using cold water drained from the ice supplying apparatus as cooling water to cool the liquid water.

13. An automated ice and liquid water vending apparatus comprising:
an ice supplying apparatus;
an ice bagging apparatus receiving a plurality of ice pieces from the ice supplying apparatus into an open end of a vending bag to form a filled ice bag comprising the vending bag and the ice pieces in the vending bag;
a bagged ice vending apparatus supplying the filled ice bag to a customer;
a liquid water supplying apparatus supplying liquid source water;
a chill tank comprising:
an insulated tank receiving cold liquid water flushed from the ice supplying apparatus; and
coiled tubing in heat exchange contact with the insulated tank, the coiled tubing receiving the liquid source water from the liquid water supplying apparatus, the liquid source water being cooled by heat exchange with the cold liquid water in the insulated tank as the liquid source water flows through the coiled tubing; and
a cold water vending line receiving the liquid source water from the coiled tubing and supplying the liquid source water to the customer.

14. The automated ice and liquid water vending apparatus of claim 13, wherein the ice bagging apparatus comprises:
a bag supplying apparatus supplying at least one vending bag having an open end;
a bag opening apparatus receiving the vending bag from the bag supplying apparatus and preparing the vending bag to receive a plurality of ice pieces from the ice supplying apparatus into the open end of the vending bag; and
a bag weighing apparatus determining when the vending bag is considered a filled ice bag and causing the ice supplying apparatus to stops supplying ice pieces to the bag weighing apparatus.

15. The automated ice and liquid water vending apparatus of claim 14, wherein the bag weighing apparatus comprises:
at least one proximity sensor; and
at least one beam receiver;
wherein the proximity sensor and the beam receiver are located such that, when the vending bag is filled with the ice pieces from the ice supplying apparatus to a level preventing the beam receiver from receiving a beam from the proximity sensor, the vending bag is considered the filled ice bag and the ice supplying apparatus stops supplying ice pieces to the bag weighing apparatus.

16. The automated ice and liquid water vending apparatus of claim 13 further comprising a control board communicating with the ice supplying apparatus, the ice bagging apparatus, and the bagged ice vending apparatus to automate vending of the ice from the automated ice vending apparatus.

17. The automated ice and liquid water vending apparatus of claim 13, wherein the ice supplying apparatus comprises:
an ice making apparatus receiving liquid water from a liquid water source and forming the plurality of ice pieces from the liquid water;
a holding vessel receiving and storing the ice pieces from the ice making apparatus; and
an ice transferring apparatus transferring and metering the ice pieces from the holding vessel to the ice bagging apparatus.

18. The automated ice and liquid water vending apparatus of claim 17, wherein the ice transferring apparatus comprises an ice transport apparatus selected from the group consisting of a conveyor belt, a chain, and a plurality of side-by-side rollers.

19. The automated ice and liquid water vending apparatus of claim 13, wherein the bag supplying apparatus comprises a wicket.

20. The automated ice and liquid water vending apparatus of claim 19, wherein the bag supplying apparatus further comprises a plurality of the at least one vending bag hanging on the wicket.

21. A method of supplying chilled liquid water from an automated ice and liquid water vending apparatus comprising:
a) receiving a request from a customer for the chilled liquid water;
b) chilling unchilled liquid water by heat exchange in a chill tank with cold liquid water flushed from an ice supplying apparatus of the automated ice and liquid water vending apparatus to turn the unchilled liquid water into the chilled liquid water; and
c) supplying the chilled liquid water to the customer.

22. The automated method of claim 21 further comprising irradiating the chilled liquid water with an ultraviolet light irradiating assembly of the ice and liquid water vending apparatus prior to supplying the chilled liquid water to the customer.

23. The automated method of claim 22 further comprising:
determining whether a control valve of the ultraviolet light irradiating assembly has been actuated within a predetermined period of time prior to receiving the request; and
if the control valve has not been actuated within the predetermined period of time, actuating the control valve to supply a predetermined amount of the chilled liquid water from an irradiation zone of the ultraviolet light irradiating assembly to a flush line prior to actuating the control valve to supply the chilled liquid water to a vending line to supply the chilled liquid water to the customer.
